(19) United States
(12) Patent Application Publication
(10) Pub. No.: US 2026/0128976 A1
(43) Pub. Date: May 7, 2026

(54) DYNAMICALLY MANAGING MOBILE NETWORK BACKHAUL CAPACITY

(71) Applicant: T-Mobile USA, Inc., Bellevue, WA (US)

(72) Inventor: Bhagwan Narayan Singh Khanka, Bothell, WA (US)

(21) Appl. No.: 18/935,423

(22) Filed: Nov. 1, 2024

(51) Int. Cl. H04L 43/0882; H04W 24/08; H04W 72/566; H04W 76/14

(52) U.S. Cl. CPC H04L 43/0882; H04W 24/08; H04W 72/566; H04W 76/14

(57) ABSTRACT

A network access node includes an antenna for communicating with antennas of multiple neighboring network access nodes. The network access node monitors its own backhaul resource utilization. When the backhaul resource utilization exceeds a first threshold, the node establishes a peer-to-peer radio connection using the antenna of a neighboring network access node. When the backhaul resource utilization of the network access node exceeds a second threshold, the node transfers, over the radio connection, a backhaul data packet associated with a wireless device that is connected to the network access node.

### BACKGROUND

In a telecommunications network, the backhaul portion of the network comprises the intermediate links between the core network, or backbone network, and small subnetworks at the edge of the network (for example private networks, local area networks, etc.). The most common network type in which backhaul is implemented is a mobile network. A backhaul of a mobile network, also referred to as a mobile backhaul, connects a cell site to the core network. The two main methods of mobile backhaul implementation are fiber-based backhaul and wireless point-to-point backhaul. Other methods, such as copper-based wireline, satellite communications, and point-to-multipoint wireless technologies, are being phased out as capacity and latency requirements become higher in 4G and 5G networks. In both the technical and commercial definitions, backhaul generally refers to the side of the network that communicates with the global Internet, paid for at wholesale commercial access rates to or at an Internet exchange point or other core network access location.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram of a system in which at least some aspects of the disclosed technology are implemented.

FIG. 4 is a chart of a process in which at least some aspects of the disclosed technology are implemented.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to systems and methods for dynamically supplementing backhaul capacity of a network access node in a mobile telecommunications network. The system can monitor backhaul (backhaul) resource utilization metrics of a plurality of network access nodes in a radio access network (RAN) of the mobile telecommunications network. When backhaul resource utilization of a first network access node of the plurality of network access nodes exceeds a first threshold, the first network access node can establish a first radio connection with a second network access node of the plurality of network access nodes. When the first radio connection is set up and when backhaul resource utilization of the first network access node exceeds a second threshold, the first network access node can send a subset of backhaul traffic carried by the first network access node, for example, backhaul traffic associated with at least one subscriber served by the first network access node, over the first radio connection to the second network access node. The second network access node can send the backhaul traffic received from the first network access node to a core network of the mobile telecommunications network. In some implementations, when backhaul resource utilization of the first network access node decreases below a third threshold, the first network access node can stop sending backhaul traffic over the first radio connection to the second network access node, and instead send backhaul traffic of the at least one user equipment (UE) served by the first network access node over its own backhaul connection.

In some implementations, the first network access node can establish the first radio connection with the second network access node using shared network resources that are shared with the at least one UE served by the first network access node. In some implementations, the first network access node can establish the first radio connection with the second network access node using network resources that are reserved for a radio connection between the first network access node and at least one network access node of the plurality of network access nodes. In some implementations, the first network access node can assign a different, i.e., either higher or lower, quality-of-service (QoS) priority to backhaul traffic sent to the second network access node than a priority assigned to traffic associated with the at least one UE served by the first network access node. In some implementations, each of the plurality of network access nodes can send its respective backhaul resource utilization indicator to the first network access node. In some implementations, when backhaul resource utilization of the first network access node exceeds an eighth threshold, the first network access node can establish a second radio connection with a third network access node of the plurality of network access nodes, and when backhaul resource utilization of the first network access node exceeds a ninth threshold, the first network access node can send a subset of backhaul traffic carried by the first network access node, for example, backhaul traffic associated with at least one subscriber served by the first network access node, over the second radio connection to the third network access node.

During normal operation of a mobile telecommunications network, scenarios can exist in which the backhaul connection of a network access node is congested, and hence limited in carrying subscriber data traffic from the network access node to the core network, even though the network access node has sufficient radio or computing resources to carry subscriber data traffic from the subscriber’s UE to the network access node. Such backhaul congestion can cause data packet loss and can result in a degraded network experience for the subscribers served by the network access node. Further, the backhaul congestion and data packet loss can result in data transmission retries, either automatic or subscriber-initiated, which can further increase traffic load on the network access node and exacerbate the backhaul congestion. Such backhaul congestion can result in higher resource utilization, thereby reducing network efficiency and overall data throughput of the mobile telecommunications network.

Thus, there exists an unmet need to supplement the backhaul capacity of a network access node experiencing backhaul congestion. The inventor has recognized that this unmet need can be met by dynamically supplementing the backhaul capacity of the network access node experiencing backhaul congestion despite having sufficient radio or computational resources by transferring some backhaul traffic from that network access node to a neighboring network access node that is not similarly experiencing backhaul congestion. The inventor has further recognized that, while the coverage footprint of a network access node may be limited to a distance of up to a few miles due to factors such as antenna downtilt or environmental clutter (e.g., buildings, foliage, and geographical features), neighboring network access nodes can communicate with each other over longer distances using dedicated antenna elements or antennas that can send signals that can travel above the environmental clutter. As such, the technologies disclosed herein enable a network access node experiencing backhaul congestion to dynamically supplement its backhaul capacity by establishing a peer-to-peer radio connection with a neighboring network access node using its unused radio and computational resources, dedicated antennas or antenna elements, and sending a subset of its backhaul traffic over the radio connection to the neighboring network access node.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

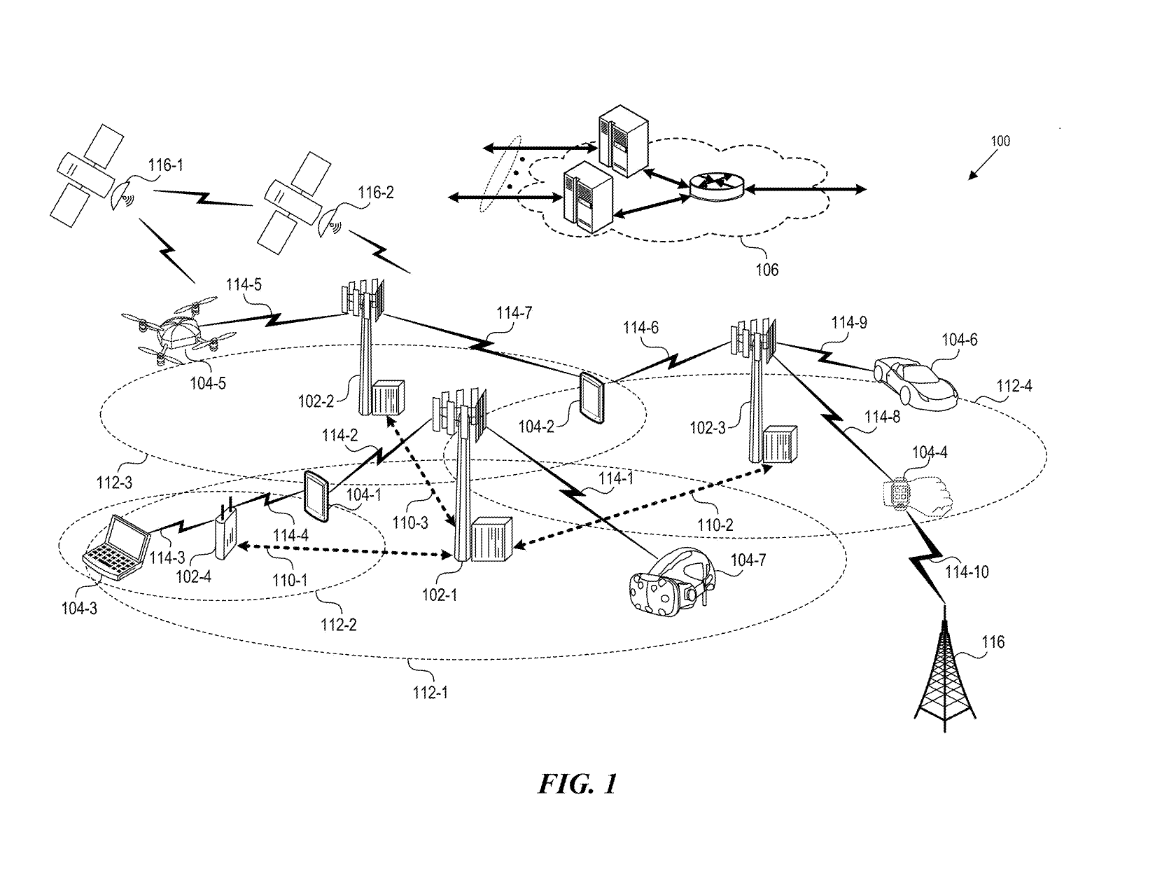

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. In some implementations, a 5G communication channel can use access frequencies of 24 GHz or more. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality-of-service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

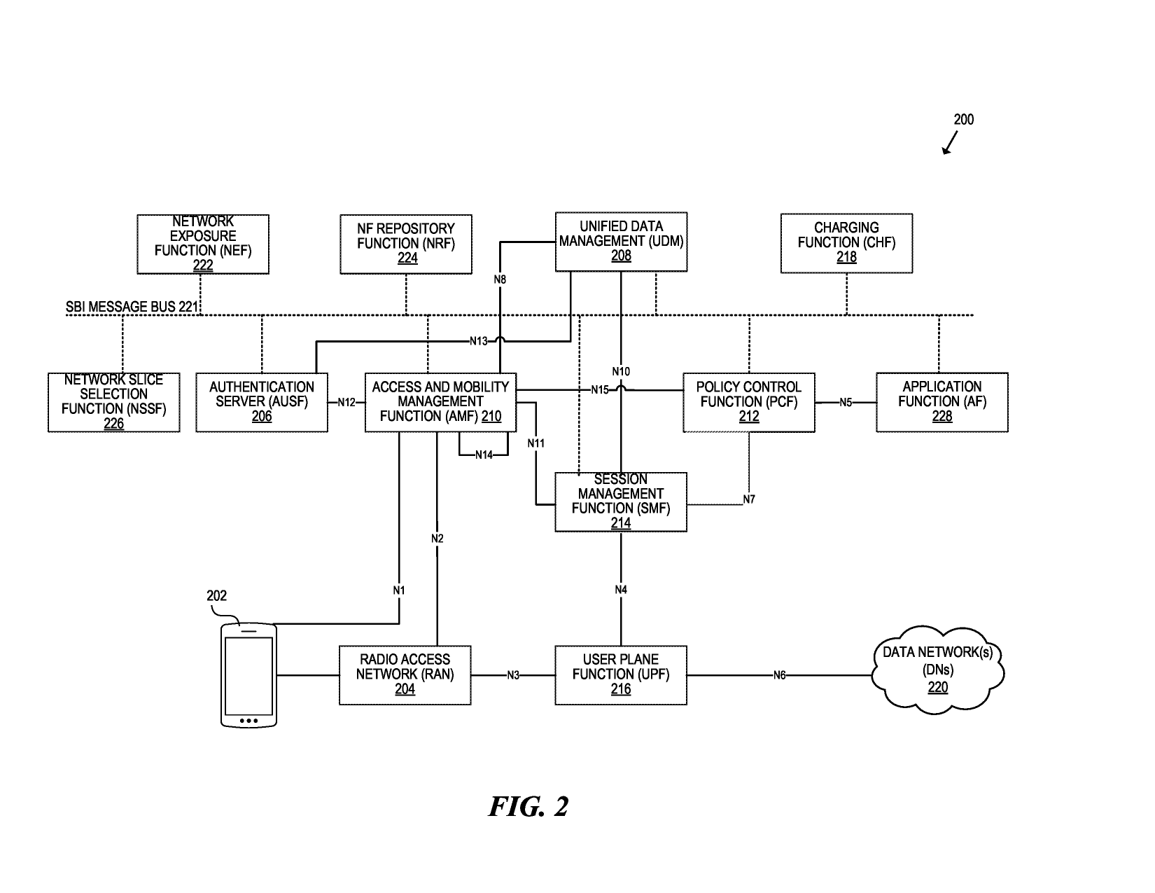

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### DYNAMICALLY MANAGING MOBILE NETWORK BACKHAUL CAPACITY

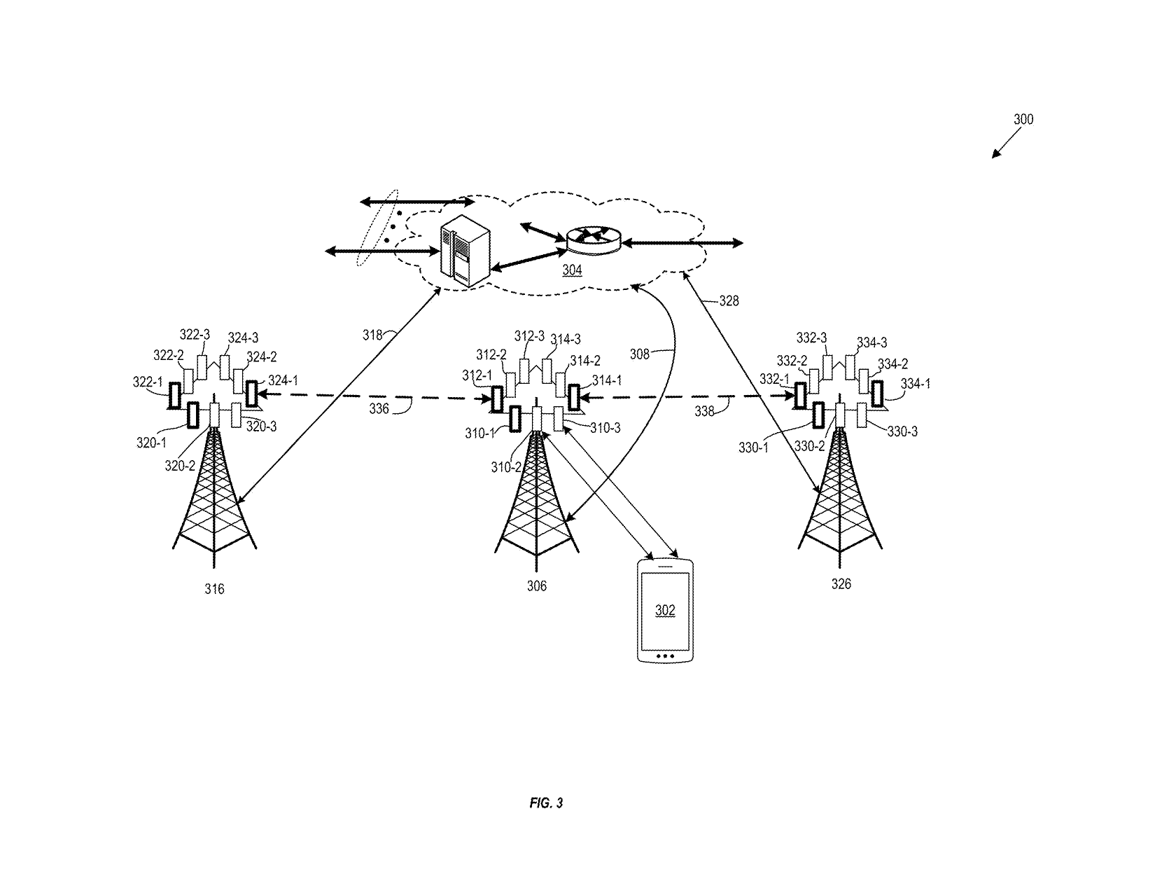

FIG. 3 is a block diagram of a system 300 in which at least some aspects of the disclosed technology are implemented. The system can include a plurality of network access nodes 306, 316, and 326 of a RAN of a mobile telecommunications network, each connected to a core network 304 of the mobile telecommunications network via their respective backhaul connections 308, 318, and 328. In some implementations, each of the network access nodes 306, 316, and 326 can include a plurality of antennas. Thus, network access node 306 can include antennas 310-1 – 310-3, 312-1 – 312-3, 314-1 – 314-3, network access node 316 can include antennas 320-1 – 320-3, 322-1 – 322-3, 324-1 – 324-3, and network access node 326 can include antennas 330-1 – 330-3, 332-1 – 332-3, 334-1 – 334-3. Antennas 310-1 – 310-3 can be collectively referred to herein as antennas 310, antennas 312-1 – 312-3 can be collectively referred to herein as antennas 312, and antennas 314-1 – 314-3 can be collectively referred to herein as antennas 314 of the network access node 306. Similarly, antennas 320-1 – 320-3 can be collectively referred to herein as antennas 320, antennas 322-1 – 322-3 can be collectively referred to herein as antennas 322, and antennas 324-1 – 324-3 can be collectively referred to herein as antennas 324 of the network access node 316. Further, antennas 330-1 – 330-3 can be collectively referred to herein as antennas 330, antennas 332-1 – 332-3 can be collectively referred to herein as antennas 332, and antennas 334-1 – 334-3 can be collectively referred to herein as antennas 334 of the network access node 326.

In some implementations, network access node 306 may be sectorized, i.e., divided into sectors, to provide service to subscribers of the mobile telecommunications network, with each sector providing service in a subset of an overall coverage footprint of network access node 306 using that sector’s set of antennas. Thus, antennas 310, 312, and 314 may each provide service to subscribers in a different geographical area; for example, antennas 310 may provide service to subscribers that are located to the south of network access node 306, antennas 312 may provide service to subscribers to the west of network access node 306, and antennas 314 may provide service to subscribers to the east of network access node 306. Access node 316 may be similarly sectorized, with each sector providing service in a subset of an overall coverage footprint of network access node 316 using that sector’s respective set of antennas 320, 322, or 324. Access node 326 may be similarly sectorized, with each sector providing service in a subset of an overall coverage footprint of network access node 326 using that sector’s respective set of antennas 330, 332, or 334.

In some implementations, antennas 310-2, 310-3, 312-2, 312-3, 314-2, 314-3, 320-2, 320-3, 322-2, 322-3, 324-2, 324-3, 330-2, 330-3, 332-2, 332-3, 334-2, and 334-3 can be configured to provide mobile telecommunications service to a wireless device 302 of a subscriber of the mobile telecommunications network. In some implementations when the disclosed technology is implemented, antennas 310-1, 312-1, 314-1, 320-1, 322-1, 324-1, 330-1, 332-1, and 334-1 can be configured to establish radio connections between each other in addition to providing service to wireless device 302. In some implementations when the disclosed technology is implemented, antennas 310-1, 312-1, 314-1, 320-1, 322-1, 324-1, 330-1, 332-1, and 334-1 can be configured to establish radio connections between each other instead of providing service to wireless device 302. Thus, for example, antenna 312-1 of network access node 306 can be configured to establish a radio connection 336 with antenna 324-1 of network access node 316, and antenna 314-1 of network access node 306 can be configured to establish a radio connection 338 with antenna 332-1 of network access node 326. While FIG. 3 shows the various antennas as separate units, a person having ordinary skill in the art will recognize that the physical form of the antennas is an implementation detail. For example, in some implementations, antennas 312-1, 312-2, and 312-3 may be implemented as physically separate antennas. In some other implementations, antennas 312-1, 312-2, and 312-3 may be combined into a single antenna body. In yet other implementations, antennas 312-1, 312-2, and 312-3 may be reduced to individual antenna elements within an antenna element array. Further, in some implementations, antennas 312-1, 312-2, and 312-3 may be individually configured to have different downtilts, whether electrical or mechanical, such that they may have different footprints regardless of whether they point in the same general direction or not. Thus, in some implementations, antenna 312-1 may have a lesser downtilt as compared to antennas 312-2 and 312-3, such that the lesser downtilt enables antenna 312-1 to transmit or receive a stronger signal to or from antenna 324-1. By comparison, antennas 312-2 and 312-3 may have a greater downtilt with the purpose of limiting propagation of signals transmitted by those antennas. A person of ordinary skill in the art will recognize that similar variations in the physical configurations of any of the antennas of network access nodes 316 and 326 are possible, and thus such variations have not been explicitly listed herein for the sake of brevity.

In some scenarios, for example when backhaul resources of network access node 306 are shared among its multiple cells or when a theoretical aggregate radio resource capacity of the one or more cells of network access node 306 exceeds the backhaul resources available at network access node 306, network access node 306 may experience backhaul congestion before it experiences radio resource congestion. Similarly, in some scenarios, when computational capacity of baseband resources such as controllers, channel cards, or other radio hardware exceeds the backhaul resources available at network access node 306, network access node 306 may experience backhaul congestion before it experiences baseband congestion.

When the disclosed technology is implemented, network access node 306 can monitor, or system 300 can cause to be monitored, a backhaul resource utilization metric of network access node 306. When the backhaul resource utilization of network access node 306 exceeds a first threshold, network access node 306 can establish a peer-to-peer radio connection 336 with network access node 316 using antenna 312-1 of network access node 306 and antenna 324-1 of network access node 316. In some implementations, radio connection 336 can be established using shared network resources of network access node 306 that are shared with wireless device 302. In some implementations, radio connection 336 can be established using network resources that are reserved for peer-to-peer radio connections such as radio connection 336. In some implementations when the mobile telecommunications network is a fourth-generation long-term evolution (4G LTE) or a fifth generation (5G) mobile telecommunications network, the network resources, whether shared or reserved, used for establishing radio connection 336 can be in the form of a resource element (RE) or a physical radio block (PRB). In some implementations, the network resources, whether shared or reserved, used for establishing radio connection 336 can be in the form of a range of frequencies in the electromagnetic spectrum. When the backhaul resource utilization of network access node 306 exceeds a second threshold, network access node 306 can send or receive a subset of its backhaul traffic, for example backhaul traffic associated with a data session of wireless device 302, over radio connection 336 to network access node 316. In turn, network access node 316 can send or receive, respectively, the backhaul traffic sent by or received from network access node 306 over radio connection 336 to the core network 304.

A person of ordinary skill in the art will recognize that once a connection is established between two entities, unless otherwise mentioned that the connection is simplex, i.e., one-way only, the same connection can be used to send or receive data packets. Thus, any references herein to an ability or step of sending backhaul traffic or backhaul data packets must be interpreted broadly as also implying an ability or step of receiving backhaul traffic or backhaul data packets, unless it is specifically mentioned that the entity can send but not receive, or receive but not send, backhaul traffic or backhaul data packets.

In some implementations, when backhaul resource utilization of network access node 316 exceeds an eleventh threshold, network access node 316 can reject establishment of the radio connection 336. In some implementations, network access node 316 can reject establishment of radio connection 336 when certain conditions are met, for example when network access node 316 identifies network access node 306 as a blacklisted neighbor that network access node 316 is prohibited from sending or receiving subscriber traffic or handovers to or from, or when network access node 316 is configured to provide fixed wireless access (FWA) service. In some implementations, before establishing radio connection 336, network access node 306 can request a backhaul capacity availability indicator and establish radio connection 336 only when the backhaul capacity availability indicator is positive, i.e., indicates that network access node 316 has sufficient backhaul capacity available. In some implementations, network access node 306 can assign a higher quality-of-service (QoS) priority to backhaul traffic sent to network access node 316 over radio connection 336 than a quality-of-service priority assigned to wireless device 302. In some implementations, network access node 306 can assign a lower quality-of-service priority to backhaul traffic sent to network access node 316 over radio connection 336 than a quality-of-service priority assigned to wireless device 302. In some implementations, network access node 306 can use a different QoS class identifier (QCI) for backhaul traffic sent to network access node 316 over radio connection 336 than a QCI used for a data flow associated with wireless device 302. In some implementations, network access nodes 306, 316, and 326 can each be configured to send their respective backhaul resource utilization metrics to each other.

In some implementations, when backhaul resource utilization of network access node 316 exceeds a twelfth threshold, network access node 316 can initiate a termination of radio connection 336. In some implementations, when backhaul resource utilization of network access node 306 exceeds an eighth threshold, network access node 306 can establish a radio connection 338 with network access node 326, and when backhaul resource utilization of network access node 306 exceeds a ninth threshold, network access node 306 can send a subset of the backhaul traffic of network access node 306 over radio connection 338 to network access node 326. In turn, network access node 326 can send or receive, respectively, the backhaul traffic sent by or received from network access node 306 over radio connection 338 to the core network 304. In some implementations, when a signal strength or signal quality associated with radio connection 336 degrades below a tenth threshold, network access node 306 can stop sending a subset of its backhaul traffic over radio connection 336 to network access node 316, and start sending it over radio connection 338 to network access node 326.

In some implementations, when backhaul resource utilization of network access node 306 decreases below a third threshold for a fourth threshold duration, network access node 306 can stop sending the subset of its backhaul traffic over radio connection 336 to network access node 316, and instead send that subset of its backhaul traffic over its own backhaul connection. In some implementations, when backhaul resource utilization of network access node 306 decreases below a fifth threshold for a sixth threshold duration, network access node 306 can terminate radio connection 336.

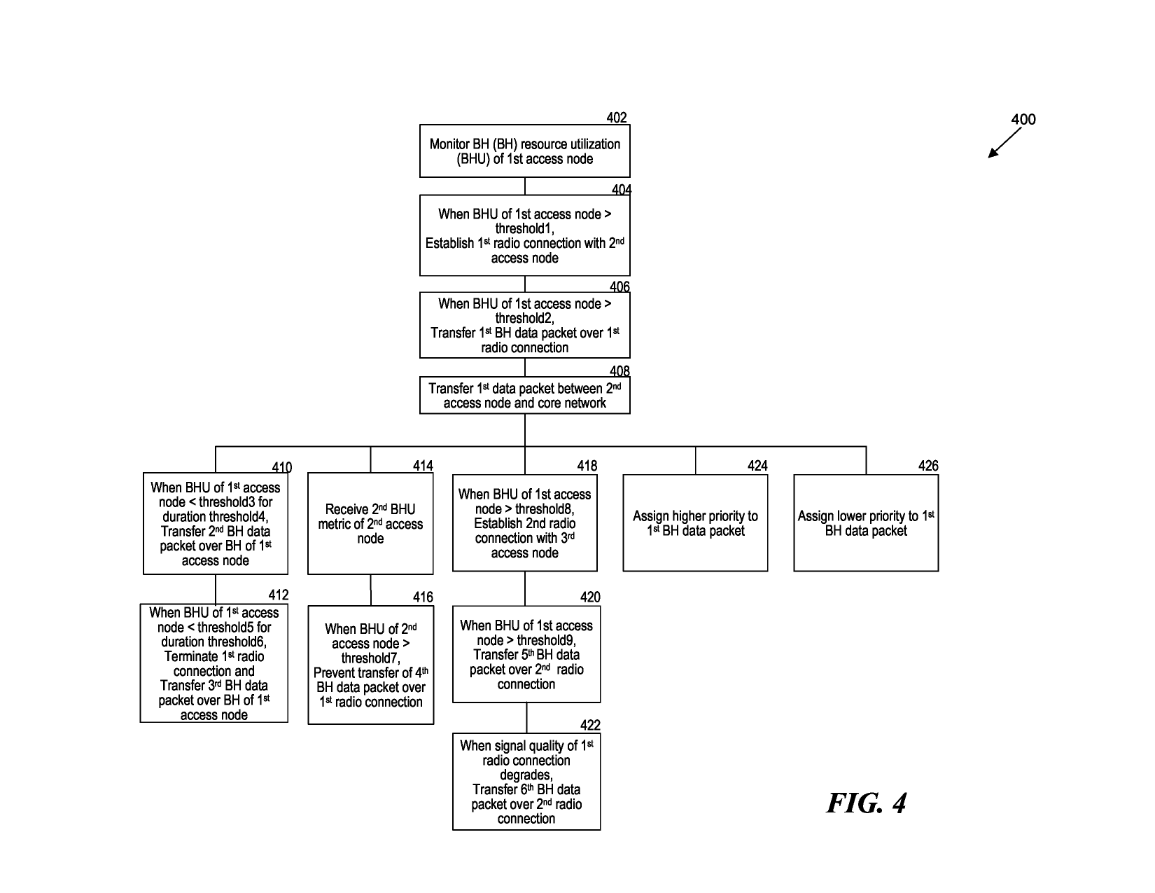

FIG. 4 is a chart of a process 400 in which at least some aspects of the disclosed technology are implemented. The process can be implemented in a system comprising a first network access node of a mobile telecommunications network. The first network access node can comprise a first antenna configured to communicate with at least a second antenna of at least one of a plurality of neighboring network access nodes of the first network access node. At 402, the system can monitor, at the first access node, a first backhaul resource utilization metric of the first network access node indicating a current backhaul resource utilization of a first backhaul connection of the first network access node. At 404, when the backhaul resource utilization of the first network access node exceeds a first threshold, the system can establish, at the first network access node, a first radio connection using the first antenna with a second network access node of the plurality of neighboring network access nodes. The first radio connection can be a peer-to-peer connection between the first network access node and the second network access node. At 406, when the backhaul resource utilization of the first network access node exceeds a second threshold, the system can transfer between the first network access node and the second network access node over the first radio connection, a first backhaul data packet associated with a wireless device that is connected to the first network access node. At 408, the system can transfer the first backhaul data packet between the second network access node and a core network of the mobile telecommunications network over a second backhaul connection of the second network access node.

At 410, when the backhaul resource utilization of the first network access node decreases below a third threshold for a fourth threshold duration, the system can prevent transfer of a second backhaul data packet associated with the wireless device between the first network access node and the second network access node over the first radio connection, and transfer the second backhaul data packet over the first backhaul connection of the first network access node. At 412, when the backhaul resource utilization of the first network access node decreases below a fifth threshold for a sixth threshold duration, the system can terminate the first radio connection between the first network access node and the second network access node and transfer a third backhaul data packet over the first backhaul connection of the first network access node. At 414, the system can receive, at the first network access node, a second backhaul resource utilization metric of the second network access node indicating a current backhaul resource utilization of a second backhaul connection of the second network access node. At 416, when the backhaul resource utilization of the second network access node exceeds a seventh threshold, the system can prevent transfer of a fourth backhaul data packet associated with the wireless device between the first network access node and the second network access node over the first radio connection. At 418, when the backhaul resource utilization of the first network access node exceeds an eighth threshold, the system can establish, at the first network access node, a second radio connection using the first antenna with a third network access node of the plurality of neighboring network access nodes. The second radio connection is a peer-to-peer connection between the first network access node and the third network access node. At 420, when the backhaul resource utilization of the first network access node exceeds a ninth threshold, the system can transfer a fifth backhaul data packet associated with the wireless device between the first network access node and the third network access node over the second radio connection. At 422, when a signal quality of the first radio connection degrades below a tenth threshold, the system can prevent transfer of a sixth backhaul data packet associated with the wireless device between the first network access node and the second network access node over the first radio connection, and transfer the sixth backhaul data packet between the first network access node and the third network access node over the second radio connection. At 424, the system can assign a higher quality-of-service priority to the first backhaul data packet than a quality-of-service priority assigned to a seventh backhaul data packet associated with the wireless device. The seventh backhaul data packet can be a data packet that is transferred by the first network access node over the first backhaul connection of the first network access node. At 426, the system can assign a lower quality-of-service priority to the first backhaul data packet than a quality-of-service priority assigned to an eighth backhaul data packet associated with the wireless device. The eighth backhaul data packet is a data packet that is transferred by the first network access node over the first backhaul connection of the first network access node.

### Computer System

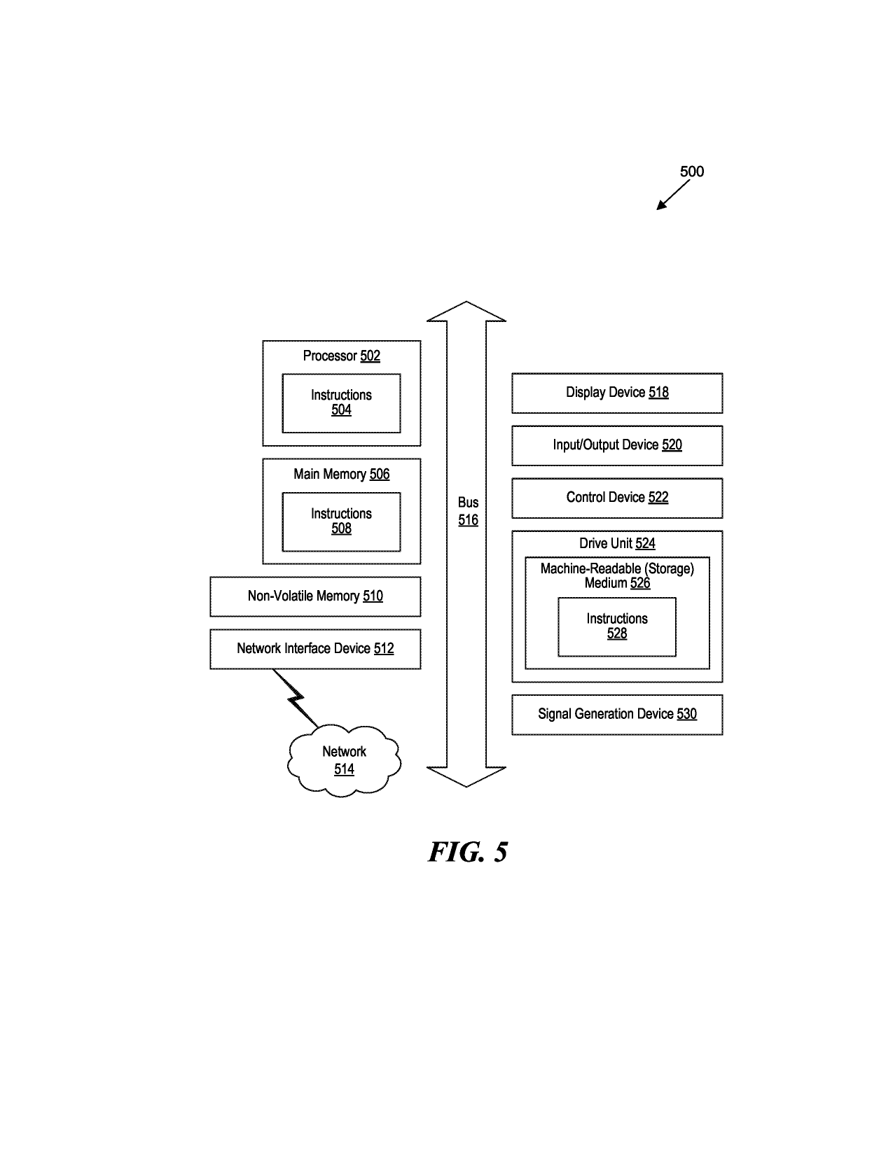

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A first network access node of a mobile telecommunications network, the first network access node comprising:
a first antenna configured to communicate with at least a second antenna of at least one of a plurality of neighboring network access nodes of the first network access node;
at least one hardware processor; and
at least one non-transitory memory storing instructions, which, when executed by the at least one hardware processor, cause the first network access node to:
monitor a first backhaul resource utilization metric of the first network access node indicating a current backhaul resource utilization of a first backhaul connection of the first network access node;
when the backhaul resource utilization of the first network access node exceeds a first threshold, establish a first radio connection using the first antenna with a second network access node of the plurality of neighboring network access nodes,
wherein the first radio connection is a peer-to-peer connection between the first network access node and the second network access node; and
when the backhaul resource utilization of the first network access node exceeds a second threshold, transfer, over the first radio connection, a first backhaul data packet associated with a wireless device that is connected to the first network access node.

2. The first network access node of claim 1 caused to:
when the backhaul resource utilization of the first network access node decreases below a third threshold for a fourth threshold duration, prevent transfer of a second backhaul data packet associated with the wireless device between the first network access node and the second network access node over the first radio connection; and
transfer the second backhaul data packet over the first backhaul connection of the first network access node.

3. The first network access node of claim 2 further caused to:
when the backhaul resource utilization of the first network access node decreases below a fifth threshold for a sixth threshold duration, terminate the first radio connection with the second network access node; and
transfer a third backhaul data packet over the first backhaul connection of the first network access node.

4. The first network access node of claim 1 caused to:
receive a second backhaul resource utilization metric of the second network access node indicating a current backhaul resource utilization of a second backhaul connection of the second network access node; and
when the backhaul resource utilization of the second network access node exceeds a seventh threshold, prevent transfer of a fourth backhaul data packet associated with the wireless device between the first network access node and the second network access node over the first radio connection.

5. The first network access node of claim 1 caused to:
when the backhaul resource utilization of the first network access node exceeds an eighth threshold, establish a second radio connection using the first antenna with a third network access node of the plurality of neighboring network access nodes,
wherein the second radio connection is a peer-to-peer connection between the first network access node and the third network access node; and
when the backhaul resource utilization of the first network access node exceeds a ninth threshold, transfer a fifth backhaul data packet associated with the wireless device between the first network access node and the third network access node over the second radio connection.

6. The first network access node of claim 5 further caused to:
when a signal quality of the first radio connection degrades below a tenth threshold, prevent transfer of a sixth backhaul data packet associated with the wireless device between the first network access node and the second network access node over the first radio connection; and
transfer the sixth backhaul data packet between the first network access node and the third network access node over the second radio connection.

7. The first network access node of claim 1 caused to:
assign a higher quality-of-service priority to the first backhaul data packet than a quality-of-service priority assigned to a seventh backhaul data packet associated with the wireless device,
wherein the seventh backhaul data packet is a data packet that is transferred by the first network access node over the first backhaul connection of the first network access node.

8. The first network access node of claim 1 caused to:
assign a lower quality-of-service priority to the first backhaul data packet than a quality-of-service priority assigned to an eighth backhaul data packet associated with the wireless device,
wherein the eighth backhaul data packet is a data packet that is transferred by the first network access node over the first backhaul connection of the first network access node.

9. A system comprising:
a first network access node of a mobile telecommunications network, the first network access node comprising a first antenna configured to communicate with at least a second antenna of at least one of a plurality of neighboring network access nodes of the first network access node;
at least one hardware processor; and
at least one non-transitory memory storing instructions, which, when executed by the at least one hardware processor, cause the system to:
monitor, at the first network access node, a first backhaul resource utilization metric of the first network access node indicating a current backhaul resource utilization of a first backhaul connection of the first network access node;
when the backhaul resource utilization of the first network access node exceeds a first threshold, establish, at the first network access node, a first radio connection using the first antenna with a second network access node of the plurality of neighboring network access nodes,
wherein the first radio connection is a peer-to-peer connection between the first network access node and the second network access node;
when the backhaul resource utilization of the first network access node exceeds a second threshold, transfer between the first network access node and the second network access node over the first radio connection, a first backhaul data packet associated with a wireless device that is connected to the first network access node; and
transfer the first backhaul data packet between the second network access node and a core network of the mobile telecommunications network,
wherein the first backhaul data packet is transferred over a second backhaul connection of the second network access node.

10. The system of claim 9 caused to:
when the backhaul resource utilization of the first network access node decreases below a third threshold for a fourth threshold duration, prevent transfer of a second backhaul data packet associated with the wireless device between the first network access node and the second network access node over the first radio connection; and
transfer the second backhaul data packet over the first backhaul connection of the first network access node.

11. The system of claim 10 further caused to:
when the backhaul resource utilization of the first network access node decreases below a fifth threshold for a sixth threshold duration, terminate the first radio connection between the first network access node and the second network access node; and
transfer a third backhaul data packet over the first backhaul connection of the first network access node.

12. The system of claim 9 caused to:
receive, at the first network access node, a second backhaul resource utilization metric of the second network access node indicating a current backhaul resource utilization of a second backhaul connection of the second network access node; and
when the backhaul resource utilization of the second network access node exceeds a seventh threshold, prevent transfer of a fourth backhaul data packet associated with the wireless device between the first network access node and the second network access node over the first radio connection.

13. The system of claim 9 caused to:
when the backhaul resource utilization of the first network access node exceeds an eighth threshold, establish, at the first network access node, a second radio connection using the first antenna with a third network access node of the plurality of neighboring network access nodes,
wherein the second radio connection is a peer-to-peer connection between the first network access node and the third network access node; and
when the backhaul resource utilization of the first network access node exceeds a ninth threshold, transfer a fifth backhaul data packet associated with the wireless device between the first network access node and the third network access node over the second radio connection.

14. The system of claim 13 further caused to:
when a signal quality of the first radio connection degrades below a tenth threshold, prevent transfer of a sixth backhaul data packet associated with the wireless device between the first network access node and the second network access node over the first radio connection; and
transfer the sixth backhaul data packet between the first network access node and the third network access node over the second radio connection.

15. The system of claim 9 caused to:
assign a higher quality-of-service priority to the first backhaul data packet than a quality-of-service priority assigned to a seventh backhaul data packet associated with the wireless device,
wherein the seventh backhaul data packet is a data packet that is transferred by the first network access node over the first backhaul connection of the first network access node.

16. The system of claim 9 caused to:
assign a lower quality-of-service priority to the first backhaul data packet than a quality-of-service priority assigned to an eighth backhaul data packet associated with the wireless device,
wherein the eighth backhaul data packet is a data packet that is transferred by the first network access node over the first backhaul connection of the first network access node.

17. A method comprising:
at a first network access node of a mobile telecommunications network, the first network access node comprising a first antenna configured to communicate with at least a second antenna of at least one of a plurality of neighboring network access nodes of the first network access node:
monitoring, at the first network access node, a first backhaul resource utilization metric of the first network access node indicating a current backhaul resource utilization of a first backhaul connection of the first network access node;
when the backhaul resource utilization of the first network access node exceeds a first threshold, establishing, at the first network access node, a first radio connection using the first antenna with a second network access node of the plurality of neighboring network access nodes,
wherein the first radio connection is a peer-to-peer connection between the first network access node and the second network access node;
when the backhaul resource utilization of the first network access node exceeds a second threshold, transferring between the first network access node and the second network access node over the first radio connection, a first backhaul data packet associated with a wireless device that is connected to the first network access node; and
transferring the first backhaul data packet between the second network access node and a core network of the mobile telecommunications network,
wherein the first backhaul data packet is transferred over a second backhaul connection of the second network access node.

18. The method of claim 17 further comprising:
when the backhaul resource utilization of the first network access node decreases below a third threshold for a fourth threshold duration, preventing transfer of a second backhaul data packet associated with the wireless device between the first network access node and the second network access node over the first radio connection;
transferring the second backhaul data packet over the first backhaul connection of the first network access node; and
when the backhaul resource utilization of the first network access node decreases below a fifth threshold for a sixth threshold duration, terminating the first radio connection between the first network access node and the second network access node.

19. The method of claim 17 further comprising:
when the backhaul resource utilization of the first network access node exceeds an eighth threshold, establishing, at the first network access node, a second radio connection using the first antenna with a third network access node of the plurality of neighboring network access nodes,
wherein the second radio connection is a peer-to-peer connection between the first network access node and the third network access node; and
when the backhaul resource utilization of the first network access node exceeds a ninth threshold, transferring a third backhaul data packet associated with the wireless device between the first network access node and the third network access node over the second radio connection.

20. The method of claim 17 further comprising:
assigning a higher quality-of-service priority to the first backhaul data packet than a quality-of-service priority assigned to a fourth backhaul data packet associated with the wireless device,
wherein the fourth backhaul data packet is a data packet that is transferred by the first network access node over the first backhaul connection of the first network access node.
